(19) United States
(12) Patent Application Publication
(10) Pub. No.: US 2021/0200114 A1
(43) Pub. Date: Jul. 1, 2021

(54) ELECTROPHOTOGRAPHIC PHOTOCONDUCTOR, AND ELECTROPHOTOGRAPHIC CARTRIDGE AND ELECTROPHOTOGRAPHIC IMAGING APPARATUS EMPLOYING THE SAME

(71) Applicant: Hewlett-Packard Development Company, L.P., Spring, TX (US)

(72) Inventors: HwanKoo LEE, Seongnam-si (KR); Hyeji SONG, Seongnam-si (KR)

(21) Appl. No.: 17/057,820

(22) PCT Filed: Jun. 26, 2019
(86) PCT No.: PCT/US2019/039274

§ 371 Date: Nov. 23, 2020

(30) Foreign Application Priority Data
Oct. 1, 2018 (KR) 10-2018-0117226

(51) Int. Cl. G03G 15/02; G03G 15/08; G03G 5/10; G03G 5/047

(52) U.S. Cl. CPC G03G 15/0258; G03G 5/047; G03G 5/10; G03G 15/08

(57) ABSTRACT

An electrophotographic photoconductor in which a surface layer of a photosensitive layer or an overcoat layer has a glass transition temperature Tg greater than 100° C. and a hardness greater than 0.22 GPa. An electrophotographic cartridge and an electrophotographic imaging apparatus include the electrophotographic photoconductor. Flipping-over of a cleaning blade that comes into contact with the electrophotographic photoconductor may be effectively suppressed or prevented, the degree of freedom in terms of cleaning blade selection may be increased, and the possibility of causing high-frequency noise due to friction may be reduced.

### BACKGROUND

In electrophotographic imaging apparatuses such as facsimile machines, printers, copy machines, and the like, the inside of a development cartridge is filled with toner particles on which external additives having a size of several to several tens of nanometers are physically coated. In a developing process, toner particles are transferred onto a surface of an electrophotographic photoconductor drum. When the developing process is completed, toner particles, external additive particles, or the like may remain on the surface of the photoconductor drum. Thus, a cleaning process of removing the residual particles from the surface of the photoconductor drum before performing the subsequent toner image forming cycle may be performed.

### BRIEF DESCRIPTION OF THE DRAWINGS

FIG. 1 is a cross-sectional view illustrating a structure of an electrophotographic photoconductor according to an example of the disclosure.

FIG. 2 is a cross-sectional view illustrating a structure of an electrophotographic photoconductor according to another example of the disclosure.

FIG. 3 is a cross-sectional view illustrating a structure of an electrophotographic photoconductor according to another example of the disclosure.

FIG. 4 is a view illustrating an example of an electrophotographic imaging apparatus and an electrophotographic cartridge, each including an electrophotographic photoconductor according to an example of the disclosure.

FIG. 5 is a graph for explaining the concept of reading a DSC curve of a glass transition temperature Tg used in the disclosure.

FIG. 6 is an actual DSC curve showing measurement results of a sample of Comparative Example 2.

### DETAILED DESCRIPTION

Although there are various cleaning methods for removing toner particles and the like, a method of scraping off residual toner or external additive particles on a surface of a photoconductor drum by using cleaning blades is widely used.

Hereinafter, an electrophotographic photoconductor according to some examples of the disclosure, and an electrophotographic cartridge and an electrophotographic imaging apparatus each including the electrophotographic photoconductor will be described in detail.

Recently, electrophotographic imaging apparatuses, which use A3- or A4-sized paper, have high-speed printing (e.g., 220 mm/sec to 334 mm/sec) and high durability of development cartridges. To meet these specifications, the surface properties of a photoconductor drum is to be controlled. In addition, cleaning blades should exhibit good cleaning performance. Cleaning defects of a photoconductor may be classified into cleaning defects due to edge tip abrasion and/or crack occurrence of a cleaning blade, and cleaning defects due to the flip-over of a cleaning blade. To enhance abrasion resistance, a material of high hardness is used to manufacture a cleaning blade, but a rubber material constituting a blade is susceptible to permanent deformation in a low-temperature environment (e.g., −5° C. to 0° C.) and thus cleaning performance easily deteriorates. On the other hand, the rubber material is soft in a high-temperature environment (e.g., 32° C. to 50° C.), and thus is easily susceptible to friction and abrasion. This increases a coefficient of friction between a cleaning blade and a photoconductor drum, thereby increasing the possibility of causing a flip-over of a cleaning blade or high-frequency noise due to friction.

As described above, since the flip-over of a cleaning blade is related to characteristics of a cleaning blade, as well as the surface properties of a photoconductor, it is difficult to effectively prevent the flip-over of a cleaning blade by controlling the characteristics of a cleaning blade.

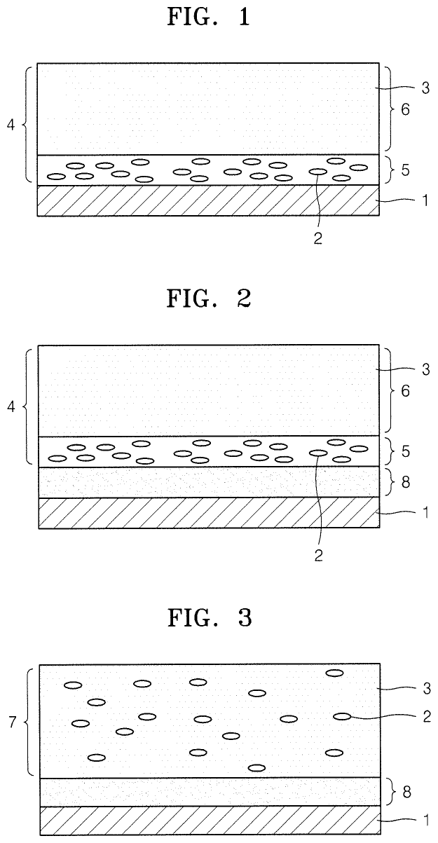

FIG. 1 is a cross-sectional view illustrating a structure of an electrophotographic photoconductor according to an example of the disclosure. Referring to FIG. 1, the electrophotographic photoconductor is a laminated-type electrophotographic photoconductor including an electroconductive support 1 formed of an electroconductive material and a photosensitive layer 4 consisting of: a charge generation layer 5 including a charge generating material 2 and a binder resin for binding the charge generating material 2; and a charge transport layer 6 including a charge transporting material 3 and a binder resin for binding the charge transporting material 3, wherein the charge generation layer 5 and the charge transport layer 6 are sequentially laminated on the electroconductive support 1, facing upward from the electroconductive support 1.

Although the charge generating material 2 and the charge transporting material 3 are illustrated in FIG. 1 in an emphasized manner, indeed, they are uniformly dispersed in components such as the binder resin, and the like of each layer.

In the example, the photosensitive layer 4 has a laminated structure of the charge generation layer 5 including the charge generating material 2 and the charge transport layer 6 including the charge transporting material 3. As such, since the layers respectively implement a charge generation function and a charge transport function, materials that best fit for the charge generation function and the charge transport function may be selected. Accordingly, an electrophotographic photoconductor having higher sensitivity, excellent stability despite repeated use, and high durability may be manufactured.

In the example, a surface or top layer of the photosensitive layer 4 satisfies the following conditions (1) and (2):

Tg>100° C. (1), and

hardness>0.22 GPa (2),

wherein Tg denotes a glass transition temperature of the photosensitive layer.

In condition (1), the Tg value may be, for example, 101° C. or more, 102° C. or more, 103° C. or more, 104° C. or more, 105° C. or more, 106° C. or more, 107° C. or more, 108° C. or more, 109° C. or more, 110° C. or more, 111° C. or more, 112° C. or more, 113° C. or more, 114° C. or more, 115° C. or more, 116° C. or more, 117° C. or more, 118° C. or more, 119° C. or more, 120° C. or more, 121° C. or more, 122° C. or more, 123° C. or more, 124° C. or more, 125° C. or more, 126° C. or more, 127° C. or more, 128° C. or more, 129° C. or more, 130° C. or more, 131° C. or more, 132° C. or more, 133° C. or more, 134° C. or more, or 135° C. or more.

In condition (2), the hardness value may be, for example, 0.221 GPa or more, 0.222 GPa or more, 0.223 GPa or more, 0.224 GPa or more, 0.225 GPa or more, 0.226 GPa or more, 0.227 GPa or more, 0.228 GPa or more, 0.229 GPa or more, 0.230 GPa or more, 0.231 GPa or more, 0.232 GPa or more, 0.233 GPa or more, 0.234 GPa or more, 0.235 GPa or more, 0.236 GPa or more, 0.237 GPa or more, 0.238 GPa or more, 0.239 GPa or more, 0.240 GPa or more, 0.242 GPa or more, 0.243 GPa or more, 0.244 GPa or more, 0.248 GPa or more, 0.249 GPa or more, 0.250 GPa or more, 0.251 GPa or more, 0.252 GPa or more, 0.280 GPa or more, 0.281 GPa or more, 0.282 GPa or more, 0.283 GPa or more, 0.284 GPa or more, 0.285 GPa or more, 0.286 GPa or more, 0.287 GPa or more, 0.288 GPa or more, 0.289 GPa or more, 0.290 GPa or more, 0.291 GPa or more, 0.292 GPa or more, 0.293 GPa or more, 0.294 GPa or more, or 0.295 GPa or more.

In the example, the surface or top layer of the photosensitive layer 4 may refer to the charge transport layer 6. However, the photosensitive layer 4 may be formed in a way opposite to the stacked order illustrated in FIG. 1. That is, a case of a laminated-type electrophotographic photoconductor having the photosensitive layer 4 in which a charge transport layer and a charge generation layer are laminated in this order, facing upward from the electroconductive support 1 is also possible. In this example of a laminated-type electrophotographic photoconductor, the surface or top layer of the photosensitive layer 4 may refer to a charge generation layer.

The flip-over of a cleaning blade is related to the characteristics of a cleaning blade itself, as well as the surface properties of the photoconductor that comes into contact with the cleaning blade. Therefore, to prevent the flip-over of a cleaning blade, it is a direct solution to enhance the characteristics of the cleaning blade itself. In the disclosure, however, the surface characteristics of a photoconductor that comes into contact with a cleaning blade may be controlled to satisfy conditions (1) and (2) as described above, thereby effectively suppressing or preventing the flip-over of a cleaning blade, as well as increasing the degree of freedom in terms of selection of a cleaning blade and achieving an additional effect of reducing the possibility of causing high-frequency noise due to friction.

Among cleaning devices for cleaning a surface of the photoconductor, a cleaning blade, which is configured to remove residues such as toner particles, external additive particles, and the like remaining on the surface of the photoconductor by coming into contact with the surface, is manufactured generally using a polyurethane as a main component. In addition, a storage modulus at −5° C., i.e., G′(MPa) @ −5° C. (unit: MPa), a storage modulus at 23° C., i.e., G′(MPa) @ 23° C. (unit: MPa), and a difference therebetween, i.e., ΔG′(MPa)(−5° C.˜23° C.) (unit: MPa) of the cleaning blade may satisfy the following conditions (3) to (5), wherein these values are obtained by dynamic viscoelastic measurement conducted as a function of temperature at a temperature ranging from about −80° C. to about 50° C. in a nitrogen atmosphere and at a measurement frequency of about 10 Hz, a heating rate of about 2.0° C./min, and an initial strain of about 0.03%:

27<G′(MPa)@−5° C.<32 (3);

10<G′(MPa)@23° C.<16 (4); and

12<ΔG′(MPa,−5° C.˜23° C.)<21 (5).

The cleaning blade satisfying conditions (3) to (5) may exhibit good cleaning performance at low and high temperatures and cleaning performance at a high speed.

As described above, the flip-over of a cleaning blade also depends on properties of the surface of a photoconductor as well as the characteristics of a cleaning blade. Thus, it is difficult to present an effective solution simply by controlling the characteristics of the cleaning blade. Therefore, in the disclosure, the surface properties of a photoconductor that comes into contact with the cleaning blade satisfying conditions (3) to (5) may be controlled to satisfy conditions (1) and (2), thereby effectively suppressing or preventing the flip-over of the cleaning blade, as well as achieving an additional effect of increasing the degree of freedom in terms of selection of a cleaning blade. Accordingly, when the photoconductor according to the disclosure and a cleaning device including the above-described cleaning blade are used in combination, efficient cleaning performance may be stably exhibited. This may be effective in, for example, maintaining effective cleaning characteristics in a high-temperature range in which elasticity of the cleaning blade is reduced.

In condition (1), the glass transition temperature Tg denotes a glass transition temperature of a photosensitive layer. Measurement conditions and methods of the glass transition temperature Tg will be described in detail in the following examples.

In condition (2), the hardness is defined as a value obtained using an indentation test in which a diamond indenter is pressed towards a sample under conditions of a maximum indentation limit of about 3,000 nm and a strain rate of about 0.05/s, using MTS Nanoindenter XP. Here, a three-sided diamond pyramid-type Berkovitch tip is used as the diamond indenter, and the thickness of the sample is maintained at average about 30 μm.

Hereinafter, each component of the electrophotographic photoconductor of the disclosure will be described in detail.

Electroconductive Support

An electroconductive material constituting the electroconductive support 1 may be, for example, a metal material such as aluminum, an aluminum alloy, copper, zinc, stainless steel, titanium, or the like. However, the disclosure is not limited to these metal materials, and polymer materials such as polyethylene terephthalate, a nylon, polystyrene, and the like; or hard paper, glass, or the like on which metal foil is laminated, a metal material is deposited, or a layer formed of an electroconductive compound such as an electroconductive polymer, tin oxide, indium oxide, or the like is deposited or coated may also be used.

The electroconductive support 1 may have a cylindrical shape (i.e., a drum shape), a columnar shape, a sheet shape, an endless belt shape, or the like.

Charge Generation Layer

The charge generation layer 5 includes, as a main component, the charge generating material 2 that generates charges by absorbing light.

Charge Generating Material

Non-limiting examples of a material suitable as the charge generating material 2 include azo-based pigments such as a monoazo-based pigment, a bisazo-based pigment, and a trisazo-based pigment; indigo-based pigments such as indigo, thioindigo, and the like; perylene-based pigments such as perylene imides and perylene acid anhydrides; polycyclic quinone-based pigments such as and pyrenequinones; phthalocyanine-based pigments such as metal phthalocyanines and non-metal phthalocyanines; squarylium pigments; pyrylium salts and thiopyrylium salts; triphenylmethane-based pigments; and inorganic materials such as selenium and amorphous silicon. The above-listed charge generating materials may be used alone or a combination of two or more of these materials may be used. Phthalocyanine-based pigments such as oxo-titanium phthalocyanine are charge generating materials having a high charge generation efficiency and a high charge injection efficiency, and thus may generate a large amount of charges by absorbing light and also effectively inject the generated charges into the charge transporting material 3 without accumulating the charges therein.

Binder Resin For Charge Generation Layer

The binder resin may be, for example, one selected from the group consisting of resins such as a polyester, polystyrene, a polyurethane, a phenolic resin, an alkyd resin, a melamine resin, an epoxy resin, a silicone resin, an acrylic resin, a methacrylic resin, a polycarbonate, a polyacrylate, a phenoxy resin, polyvinyl butyral, polyvinyl formal, and the like; copolymer resins containing two or more of repeating units constituting these resins; and the like, or a combination of two or more of these materials may be used. Non-limiting examples of the copolymer resins include insulating resins such as a vinyl chloride-vinyl acetate copolymer, a vinyl chloride-vinyl acetate-maleic anhydride copolymer, and an acrylonitrile-styrene copolymer. The disclosure is not limited to these binder resins, and generally used resins may be used as the binder resin.

Solvent for Coating Solution of Charge Generation Layer

A suitable solvent may be, for example, a halogenated hydrocarbon such as dichloromethane, dichloroethane, or the like; a ketone such as acetone, methyl ethyl ketone, cyclohexanone, or the like; an ester such as ethyl acetate, butyl acetate, or the like; an ether such as tetrahydrofuran (THF), dioxane, or the like; an alkyl ether of ethylene glycol, such as 1,2-dimethoxy ethane or the like; an aromatic hydrocarbon such as benzene, toluene, xylene, or the like; or an aprotic polar solvent such as N,N-dimethylformamide, N,N-dimethylacetamide, or the like. In addition, a mixed solvent of two or more of the above-listed solvents may also be used.

Coating Solution For Charge Generation Layer

A mixing ratio of the charge generating material 2 to the binder resin may be adjusted such that the proportion of the charge generating material 2 is in the range of about 10 mass % to about 99 mass %. Thus, dispersibility of the charge generating material 2, film strength of the charge generation layer 5, and sensitivity of the charge generation layer 5 may remain good.

Method of Forming Charge Generation Layer

The charge generation layer 5 may be formed using a method of performing vacuum deposition of the charge generating material 2 on the electroconductive support 1, or a method of coating the electroconductive support 1 with a coating solution for a charge generation layer, which is obtained by dispersing the charge generating material 2 in a solvent, or the like. Among these methods, a method of coating the electroconductive support 1 with a coating solution, which is obtained by dispersing the charge generating material 2 in a binder resin solution obtained by mixing a binder resin in a solvent may be efficiently used. However, this method will be described in further detail.

Before the charge generating material 2 is dispersed in the binder resin solution, the charge generating material 2 may be previously pulverized by a pulverizer. The pulverizer used in the pulverizing process may be a ball mill, a sand mill, an attritor, a vacuum mill, a sonicator, or the like.

A disperser used in dispersing the charge generating material 2 in the binder resin solution may be a paint shaker, a ball mill, a sand mill, or the like. In this case, appropriate dispersion conditions not allowing impurities to be entrained due to abrasion of materials constituting a used container and disperser, or the like are selected.

As a method of coating the coating solution for a charge generation layer, which is obtained by dispersing the charge generating material 2 in a binder resin solution, a spray coating method, a bar coating method, a roll coating method, a doctor blade coating method, a ring coating method, a dip coating method, or the like may be used. Among these coating methods, an optimum method may be selected in consideration of properties of coatings, productivity, and the like. For example, dip coating is a method of dipping the electroconductive support 1 into a bath filled with a coating solution, and then forming a layer on the electroconductive support 1 by pulling up the electroconductive support 1 from the bath at a constant speed or an increased varying speed. This method is relatively simple, and excellent in terms of productivity and raw material costs, and thus is widely used in manufacturing an electrophotographic photoconductor. To stabilize the dispersibility of a coating solution, a coating solution disperser as a representative example of an ultrasonic generator may be installed in an apparatus used in dip coating.

The film thickness of the charge generation layer 5 may range from about 0.05 μm to about 5 μm, for example, about 0.1 μm to about 1 μm, to appropriately maintain the sensitivity of the photoconductor.

Charge Transport Layer

The charge transport layer 6 may be obtained by including an organic photoconductive material, as the charge transporting material 3, having a capability of accepting and transporting charges generated from the charge generating material 2 in a binder resin.

Charge Transporting Material

Non-limiting examples of a suitable charge transporting material include carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone derivatives, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylene diamine derivatives, stilbene derivatives, and benzidine derivatives. In addition, polymers having, in a main chain or a side chain, moieties derived from the above-listed compounds, e.g., poly-N-vinylcarbazole, poly-1-vinylpyrene, poly-9-vinylanthracene, and the like may also be used.

Binder Resin for Charge Transport Layer

As the binder resin used in the charge transport layer 6, a binder resin having excellent compatibility with the charge transporting material 3 is selected. Non-limiting examples of the binder resin include vinyl polymers such as polymethyl methacrylate, polystyrene, and polyvinyl chloride, and copolymers thereof; and resins such as a polycarbonate, a polyester, a polyester carbonate, a polysulfone, a phenoxy resin, an epoxy resin, a silicone resin, a polyarylate, a polyamide, a polyether, a polyurethane, a polyacrylamide, and a phenolic resin. In addition, thermosetting resins partially cross-linked with these resins may also be used. These resins may be used alone or a mixture of two or more of these resins may be used. Polystyrene, a polycarbonate, a polyarylate, or polyphenylene oxide has excellent electrical insulation, excellent film formability, excellent potential properties, and the like.

A ratio (A/B) of the charge transporting material (A) to the binder resin (B) may be adjusted to, for example, from about 10/10 to about 10/30, for example, from about 10/12 to about 10/30, in terms of photo-responsiveness, abrasion resistance, durability, and prevention of the flip-over of a cleaning blade. When the ratio A/B is less than 10/30, i.e., the proportion of the binder resin increases, in a case in which the charge transport layer 6 is formed by dip coating, the viscosity of the coating solution increases, thus causing a reduction in coating speed, resulting in reduced productivity. When the ratio A/B is greater than 10/10, i.e., the proportion of the binder resin decreases, abrasion resistance is reduced as compared to the case in which the proportion of the binder resin is high, and thus the abrasion amount of a photosensitive layer increases.

Additive for Charge Transport Layer

To enhance film formability, flexibility, and surface smoothness, as needed, an additive such as a plasticizer, a leveling agent, or the like may be added to the charge transport layer 6. Non-limiting examples of the plasticizer include dibasic acid esters, fatty acid esters, phosphoric acid esters, phthalic acid esters, chlorinated paraffins, and epoxy-type plasticizers. The leveling agent may be a silicone-based leveling agent, or the like.

To increase mechanical strength or enhance electrical characteristics, the charge transport layer 6 may also include fine particles of an inorganic compound or an organic compound. As needed, various additives such as an antioxidant, a sensitizer, and the like may also be added to the charge transport layer 6. Thus, these additives may enhance potential properties, increase the stability of a coating solution, reduce fatigue deterioration when the photoconductor is repeatedly used, and enhance durability.

The antioxidant may be a hindered phenol derivative or a hindered amine derivative. The hindered phenol derivative may be used in an amount of about 0.1 mass % to about 50 mass % with respect to a total amount of the charge transporting material 3. The hindered amine derivative may be used in an amount of about 0.1 mass % to about 50 mass % with respect to a total amount of the charge transporting material 3. A mixture of the hindered phenol derivative and the hindered amine derivative may also be used. In this case, a total amount of the hindered phenol derivative and hindered amine derivative used may be in a range of about 0.1 mass % to about 50 mass % with respect to the total amount of the charge transporting material 3.

Method of Forming Charge Transport Layer

The charge transport layer 6 may be formed using the same method as the above-described method for forming the charge generation layer 5. For example, first, the charge transporting material 3, a binder resin, and optionally, the above-described additives are dissolved or dispersed in a suitable solvent to prepare a coating solution for forming a charge transport layer. The coating solution is coated onto the charge generation layer 5 by spraying, bar coating, roll coating, a blade method, a ring method, dip coating, or the like, thereby forming the charge transport layer 6.

The solvent used in a coating solution may be one selected from the group consisting of aromatic hydrocarbons such as benzene, toluene, xylene, monochlorobenzene, and the like; halogenated hydrocarbons such as dichloromethane, dichloroethane, and the like; ethers such as THF, dioxane, dimethoxy methyl ether, and the like; and aprotic polar solvents such as N,N-dimethylformamide, and the like, or a mixture of two or more of these solvents may be used. As needed, a solvent such as an alcohol-based solvent, acetonitrile, methyl ethyl ketone, or the like may be further added to the above-listed solvents.

The film thickness of the charge transport layer 6 may range from about 5 μm to about 50 μm, for example, about 10 μm to about 40 μm, to maintain the surface charging performance of a photoconductor and prevent the resolution of a photoconductor from being reduced.

Additive for Photosensitive Layer

The photosensitive layer 4 may further include electron accepting materials or pigments, to enhance sensitivity and inhibit an increase in residual potential and fatigue during repeated use.

Non-limiting examples of the electron accepting material include acid anhydrides such as succinic anhydride, maleic anhydride, phthalic anhydride, and 4-chloronaphthalic anhydride; cyano compounds such as tetracyanoethylene and terephthalmalononitrile; aldehydes such as 4-nitrobenzaldehyde; anthraquinones such as anthraquinone and 1-nitroanthraquinone; polycyclic and heterocyclic nitro compounds such as 2,4,7-trinitrofluorenone and 2,4,5,7-tetranitrofluorenone; and electron attracting materials such as diphenoquinone compounds, or polymerized materials of these electron attracting materials.

The pigment may be, for example, an organic photoconductive compound such as a xanthene-based dye, a thiazine dye, a triphenylmethane dye, a quinoline-based pigment, copper phthalocyanine, or the like. These organic photoconductive compounds function as optical sensitizers.

Overcoat Layer

To protect the photosensitive layer 4, an overcoat layer (not shown) may be formed on a surface or top of the photosensitive layer 4 such that the overcoat layer becomes a surface or top layer of the photosensitive layer 4. The formation of the overcoat layer may enhance the abrasion resistance of the photosensitive layer 4 and also prevent ozone, a nitrogen oxide, or the like that is generated by corona discharge when the surface of a photoconductor is charged from chemically and adversely affecting the photosensitive layer 4.

The overcoat layer includes a binder resin and an electroconductive material, and may be formed of a photocured product of a composition for forming an overcoat layer, which includes a photocurable compound, a photoinitiator, an electroconductive material, and a solvent.

The photocurable compound is not limited, but for example, a monofunctional (meth)acrylic acid ester, a bifunctional (meth)acrylic acid ester, and a trifunctional or greater (meth)acrylic acid ester have good polymerizability and may enhance strength of the obtained overcoat layer.

Non-limiting examples of the monofunctional (meth)acrylic acid ester include 2-hydroxyethyl acrylate, 2-hydroxyethyl methacrylate, diethylene glycol monoethyl ether acrylate, diethylene glycol monoethyl ether methacrylate, isobornyl acrylate, isobornyl methacrylate, 3-methoxybutyl acrylate, 3-methoxybutyl methacrylate, (2-acryloyloxyethyl)(2-hydroxypropyl)phthalate, (2-methacryloyloxyethyl)(2-hydroxypropyl)phthalate, and ω-carboxy-polycaprolactone monoacrylate.

Non-limiting examples of the bifunctional (meth)acrylic acid ester include ethylene glycol diacrylate, ethylene glycol dimethacrylate, diethylene glycol diacrylate, diethylene glycol dimethacrylate, tetraethylene glycol diacrylate, tetraethylene glycol dimethacrylate, 1,6-hexanediol diacrylate, 1,6-hexanediol dimethacrylate, 1,9-nonanediol diacrylate, 1,9-nonanediol dimethacrylate, bisphenoxy ethanol fluorene diacrylate, and bisphenoxy ethanol fluorene dimethacrylate.

Non-limiting examples of the trifunctional or greater (meth)acrylic acid ester include trimethylol propane triacrylate, trimethylol propane trimethacrylate, pentaerythritol triacrylate, pentaerythritol trimethacrylate, pentaerythritol tetraacrylate, pentaerythritol tetramethacrylate, dipentaerythritol pentaacrylate, dipentaerythritol pentamethacrylate, dipentaerythritol hexaacrylate, dipentaerythritol hexamethacrylate, tri(2-acryloyloxyethyl)phosphate, and tri(2-methacryloyloxyethyl)phosphate.

Among the above-listed photocurable compounds, the trifunctional or greater (meth)acrylic acid esters may be used to enhance abrasion resistance through a high degree of crosslinking, and examples thereof include trimethylol propane triacrylate, pentaerythritol triacrylate, pentaerythritol tetraacrylate, dipentaerythritol pentaacrylate, dipentaerythritol hexaacrylate, and multifunctional urethaneacrylate-based compounds.

The monofunctional, bifunctional, or trifunctional or greater (meth)acrylic acid esters may be used alone or a mixture of two or more of these esters may be used.

The electroconductive material is not limited, but may be at least one selected from the group consisting of copper, tin, aluminum, indium, silica, tin oxide, zinc oxide, titanium dioxide, aluminum oxide (Al₂O₃), zirconium oxide, indium oxide, antimony oxide, bismuth oxide, calcium oxide, antimony-doped tin oxide (ATO), and carbon nanotubes.

An amount of the electroconductive material in the composition for forming an overcoat layer may be, for example, in a range of about 5 parts by weight to about 40 parts by weight, for example, about 15 parts by weight to about 25 parts by weight, with respect to 100 parts by weight of the photocurable compound. When the amount of the electroconductive material is within the range of about 5 parts by weight to about 40 parts by weight, the electroconductive material has a sufficient charge transporting capability, and thus may prevent an increase in residual potential due to lack of sensitivity and enhance chargeability and mechanical strength of the overcoat layer. The overcoat layer is formed by evaporating a solvent in the composition for forming an overcoat layer, and thus the amount of the electroconductive material in the composition ultimately corresponds to the amount of the electroconductive material in the formed overcoat layer.

The photoinitiator may be any material that generates active species capable of initiating polymerization of the above-described photocurable compound by exposure to light, such as visible light, ultraviolet rays, far-ultraviolet rays, charged particle beams, or the like, without limitation. For example, the photoinitiator may be, for example, an O-acyloxime-based compound, an acetophenone-based compound, a biimidazole-based compound, a benzoin-based compound, a benzophenone-based compound, an α-diketone-based compound, a polynuclear quinone-based compound, a xanthone-based compound, a phosphine-based compound, a triazine-based compound, or the like. As a commercially available product of the photoinitiator, Irgacure® 127, Irgacure® 184, Irgacure® 819, Irgacure® 127, or Irgacure® 754, which is available from Ciba Specialty Chemical, may be used, but the disclosure is not limited thereto.

An amount of the photoinitiator may be, for example, in a range of about 1 part by weight to about 20 parts by weight, or about 2 parts by weight to about 10 parts by weight, with respect to 100 parts by weight of the photocurable compound. When the amount of the photoinitiator is within the range of about 1 part by weight to about 20 parts by weight, a curing reaction sufficiently occurs, and thus the formed overcoat layer may have sufficient hardness, and exhibit increased mechanical strength, resulting in enhanced abrasion resistance.

Examples of a solvent used in the composition for forming an overcoat layer include, but are not limited to, aromatic hydrocarbons such as benzene, xylene, ligroin, monochlorobenzene, and dichlorobenzene; ketones such as acetone, methyl ethyl ketone, and cyclohexanone; alcohols such as methanol, ethanol, isopropanol, n-propanol, and n-butanol; esters such as ethyl acetate and methyl cellosolve; aliphatic halogenated hydrocarbons such as carbon tetrachloride, chloroform, dichloromethane, dichloroethane, and trichloroethylene; ethers such as tetrahydrofuran, dioxane, dioxolane, and ethylene glycol monomethyl ether; amides such as N,N-dimethyl formamide and N,N-dimethyl acetamide; and sulfoxides such as dimethyl sulfoxide. These solvents may be used alone or a mixture of two or more of these solvents may be used.

An amount of the solvent may be, for example, in a range of about 300 parts by weight to about 700 parts by weight, or about 400 parts by weight to about 600 parts by weight, with respect to 100 parts by weight of the photocurable compound. When the amount of the solvent is within the range of about 300 parts by weight to about 700 parts by weight, the solvent may uniformly dissolve each component constituting the composition for forming an overcoat layer, and may be completely removed in forming an overcoat layer, thereby providing an overcoat layer with abrasion resistance.

The overcoat layer is formed through coating, drying, and photo-curing processes. First, the coating method is not limited, and a dip coating method, a spray coating method, a spin coating method, a wire bar coating method, a ring coating method, or the like, may be used. After coating, the drying process may be performed at about 50° C. to about 200° C. for about 5 minutes to about 30 minutes. After the drying process, the solvent may be evaporated, and then photocuring, e.g., ultraviolet curing, may be performed using a photocuring system, and a power condition of a lamp during curing may be adjusted to about 80 W to about 120 W. The photoconductor may be rotated for uniform curing. A rotating velocity may be, for example, in a range of about 5 rpm to about 40 rpm. The curing time varies depending on the thickness of the overcoat layer and the rotating velocity of the photoconductor, but may range from about 20 seconds to about 100 seconds. When the curing time is within the range of about 20 seconds to about 100 seconds, issues caused by incomplete curing or excessive curing, such as damage to the photoconductor or deterioration of sensitivity characteristics of the photoconductor may be prevented.

The thickness of the formed overcoat layer may be, for example, in a range of about 0.5 μm to about 10 μm, or about 0.5 μm to about 4 μm. When the thickness of the overcoat layer as a protective layer is within the range of about 0.5 μm to about 10 μm, issues, such as an insufficient effect of the protective layer due to a too small thickness thereof or a reduction in quality of printed images may be prevented.

In a case in which the overcoat layer (not shown) is formed on the surface of the photosensitive layer 4 as a top layer of the photosensitive layer 4, to effectively prevent the flip-over of a cleaning blade, the type, amount, and the like of the photocurable compound, the photoinitiator, and the electroconductive material are adjusted to control the overcoat layer to satisfy the following conditions (1) and (2):

Tg>100° C. (1), and

hardness>0.22 GPa (2),

wherein Tg denotes a glass transition temperature of the overcoat layer.

Undercoat Layer

FIG. 2 is a cross-sectional view illustrating a structure of an electrophotographic photoconductor according to another example of the disclosure. Referring to FIG. 2, in the electrophotographic photoconductor, the same elements as those of the electrophotographic photoconductor illustrated in FIG. 1 have like reference numerals, and a detailed description thereof will be omitted herein. The example is different from the example of FIG. 1 in that an undercoat layer 8 is further provided between the electroconductive support 1 and the photosensitive layer 4.

In a case in which the undercoat layer 8 is not provided between the electroconductive support 1 and the photosensitive layer 4, charges are injected into the photosensitive layer 4 from the electroconductive support 1, and thus the chargeability of the photosensitive layer 4 may deteriorate. Thus, surface charges other than surface charges at a position where they are to be eliminated by light exposure decrease, resulting in occurrence of image defects. For example, in a case in which an image is formed using a reverse development process in which a toner image is formed at a position where surface charges decrease due to light exposure, when surface charges decrease due to factors other than light exposure, toner is adhered to a white background, and thus minute black spots are formed, resulting in remarkable image quality deterioration. That is, deterioration of chargeability in a minute area is caused by defects of the electroconductive support 1 or the photosensitive layer 4, and accordingly, image defects may occur.

By forming the undercoat layer 8, charge injection from the electroconductive support 1 into the photosensitive layer 4 may be prevented, and thus deterioration of the chargeability of the photosensitive layer 4 may be effectively prevented, and a reduction in surface charges other than surface charges at a position where they are to be eliminated by light exposure may be suppressed, thereby effectively preventing the occurrence of image defects. In addition, by forming the undercoat layer 8, defects on the surface of the electroconductive support 1 may be covered to obtain a uniform surface, and thus film formability of the photosensitive layer 4 may be enhanced. In addition, separation of the photosensitive layer 4 from the electroconductive support 1 may be prevented, and thus adhesion between the electroconductive support 1 and the photosensitive layer 4 may be enhanced.

As the undercoat layer 8, a resin layer formed of various resin materials, an alumite layer, or the like may be used. Examples of resin materials constituting the resin layer include resins such as polyethylene, polypropylene, polystyrene, an acrylic resin, a vinyl chloride resin, a vinyl acetate resin, a polyurethane, an epoxy resin, a polyester, a melamine resin, a silicone resin, polyvinyl butyral, a polyamide, and the like; copolymer resins containing two or more of repeating units constituting these resins; casein; gelatin; polyvinyl alcohol; ethyl cellulose; and the like. For example, alcohol-soluble polyamide resins obtained by chemically modifying nylons, such as copolymeric nylons, which are prepared by copolymerizing nylon-6, nylon-66, nylon-610, nylon-11, nylon-12, or the like; N-alkoxymethyl modified nylons; and N-alkoxyethyl modified nylons, may be used.

The undercoat layer 8 may include particles of a metal oxide or the like. By including these particles, the volume resistivity of the undercoat layer 8 may be adjusted, charge injection from the electroconductive support 1 into the photosensitive layer 4 may be further prevented, and the electrical characteristics of the photosensitive layer 4 may be maintained in various environments. Examples of the particles of a metal oxide include particles of titanium oxide, aluminum oxide, aluminum hydroxide, tin oxide, and the like.

When the undercoat layer 8 includes particles of a metal oxide or the like, for example, the undercoat layer 8 may be formed by dispersing the particles of a metal oxide or the like in a resin solution in which one of the above-described resins is dissolved, to prepare a coating solution for an undercoat layer, and coating the electroconductive support 1 with the coating solution. As a solvent of the resin solution, water or various organic solvents may be used. For example, a single solvent such as water, methanol, ethanol, butanol, or the like; a mixed solvent of water and an alcohol; a mixed solvent of two or more alcohols; a mixed solvent of acetone, dioxolane, etc and an alcohol; or a mixed solvent of a chlorine-based solvent, such as dichloroethane, chloroform, trichloroethane, or the like, and an alcohol; or the like may be used.

The dispersion of the particles in the resin solution may be performed using a ball mill, a sand mill, an attritor, a vacuum mill, a sonicator, or the like.

A total amount C of the resin and the metal oxide in the coating solution for an undercoat layer may be adjusted such that, with respect to an amount D of the solvent used in the coating solution for an undercoat layer, a mass ratio (C/D) is in a range of about 1/99 to about 40/60, for example, about 2/98 to about 30/70. A mass ratio of the resin to the metal oxide (resin/metal oxide) may range from about 90/10 to about 1/99, for example, about 70/30 to about 5/95.

The coating of the coating solution for an undercoat layer may be performed by spraying, bar coating, roll coating, blade coating, ring coating, or dip coating. For example, the dip coating method is relatively simple and excellent in terms of productivity and raw material costs as described above, and thus may be widely used even in forming the undercoat layer 8.

The undercoat layer 8 may have a film thickness of about 0.01 μm to about 20 μm, for example, about 0.05 μm to about 10 μm. By setting the film thickness of the undercoat layer 8, the undercoat layer 8 having a uniform surface may be efficiently formed and the chargeability and sensitivity of the photosensitive layer 4 may remain good.

Monolayer-Type Electrophotographic Photoconductor

FIG. 3 is a cross-sectional view illustrating a structure of an electrophotographic photoconductor according to another example of the disclosure. In the electrophotographic photoconductor, portions corresponding to those of the electrophotographic photoconductor illustrated in FIG. 2 have like reference numerals, and a description thereof will be omitted herein. The example differs from the previous example in that the electrophotographic photoconductor of FIG. 3 is a monolayer-type electrophotographic photoconductor including a photosensitive layer 7 formed as a single layer by including both the charge generating material 2 and the charge transporting material 3 in a binder resin.

The photosensitive layer 7 may be formed using the same method as the above-described method of forming the charge transport layer 6. For example, first, the charge generating material 2, the charge transporting material 3, and a binder resin are dissolved or dispersed in the above-described appropriate solvent to prepare a coating solution for a photosensitive layer. The coating solution for a photosensitive layer may be coated onto the undercoat layer 8 by dip coating or the like, thereby forming the photosensitive layer 7.

A mass ratio of the charge transporting material 3 to the binder resin in the photosensitive layer 7 may be in a range of about 10/10 to about 10/30, for example, about 10/12 to about 10/30, like the above-described ratio A/B of the charge transporting material 3 and the binder resin in the charge transport layer 6.

A film thickness of the photosensitive layer 7 may range from about 5 μm to about 100 μm, for example, about 10 μm to about 50 μm, in terms of charge retention of the surface of the photoconductor, productivity, and the like.

The electrophotographic photoconductor according to the disclosure is not limited to the structures illustrated in FIGS. 1 to 3, but may have various layered structures.

In addition, if needed, various additives such as an antioxidant, a sensitizer, an ultraviolet absorber, and the like may be added to each layer of the photoconductor. Accordingly, potential characteristics may be enhanced. In addition, the stability of the coating solution when coated to form a layer may be increased. In addition, fatigue deterioration during repeated use of the photoconductor may be suppressed and durability may be enhanced.

Non-limiting examples of the antioxidant include phenol-based compounds, hydroquinone-based compounds, tocopherol-based compounds, and amine-based compounds. These antioxidants may be used in an amount of about 0.1 mass % to about 50 mass % with respect to a total amount of the charge transporting material 3. Accordingly, a sufficient effect of enhancing the stability of the coating solution and enhancing the durability of the photoconductor may be obtained, and deterioration of the characteristics of the photoconductor may be prevented.

Hereinafter, an electrophotographic imaging apparatus and an electrophotographic cartridge each including the electrophotographic photoconductor according to the disclosure will be described. However, the electrophotographic imaging apparatus is not limited to the following example descriptions.

The electrophotographic photoconductor according to the disclosure may be incorporated into an electrophotographic cartridge or an electrophotographic imaging apparatus, such as a laser printer, a copier, a facsimile machine, or the like.

An electrophotographic imaging apparatus according to another example of the disclosure includes: the electrophotographic photoconductor according to the disclosure; a charging device configured to charge the electrophotographic photoconductor while in contact or not in contact with the electrophotographic photoconductor; an exposure device configured to form an electrostatic image on a surface of the electrophotographic photoconductor; a developing device configured to form a visible image by developing the electrostatic image; a transfer device configured to transfer the visible image onto an image-receiving member; and a cleaning device configured to clean the surface of the electrophotographic photoconductor after the transfer of the visible image.

An electrophotographic cartridge according to another example of the disclosure includes: the electrophotographic photoconductor according to the disclosure; and at least one device selected from the group consisting of a charging device configured to charge the electrophotographic photoconductor while in contact or not in contact with the electrophotographic photoconductor; a developing device configured to form a visible image by developing the electrostatic image formed on the electrophotographic photoconductor; and a cleaning device configured to clean a surface of the electrophotographic photoconductor after the transfer of the visible image formed on the electrophotographic photoconductor onto an image-receiving member, wherein the electrophotographic cartridge may integrally support the electrophotographic photoconductor and the at least one device, and may be attachable to or detachable from an electrophotographic imaging apparatus.

In the electrophotographic imaging apparatus or electrophotographic cartridge according to the disclosure, the cleaning device includes a cleaning blade configured to remove residuals on the surface of the electrophotographic photoconductor while in contact with the surface, wherein a storage modulus at −5° C., i.e., G′(MPa) @ −5° C. (unit: MPa), a storage modulus at 23° C., i.e., G′(MPa) @ 23° C. (unit: MPa), and a difference therebetween, i.e., ΔG′(MPa)(−5° C.˜23° C.) (unit: MPa) of the cleaning blade may satisfy the following conditions, wherein these values are obtained by dynamic viscoelastic measurement conducted as a function of temperature at a temperature ranging from about −80° C. to about 50° C. in a nitrogen atmosphere and at a measurement frequency of about 10 Hz, a heating rate of about 2.0° C./min, and an initial strain of about 0.03%:

27<G′(MPa)@−5° C.<32;

10<G′(MPa)@23° C.<16; and

12<ΔG′(MPa,−5° C.˜23° C.)<21.

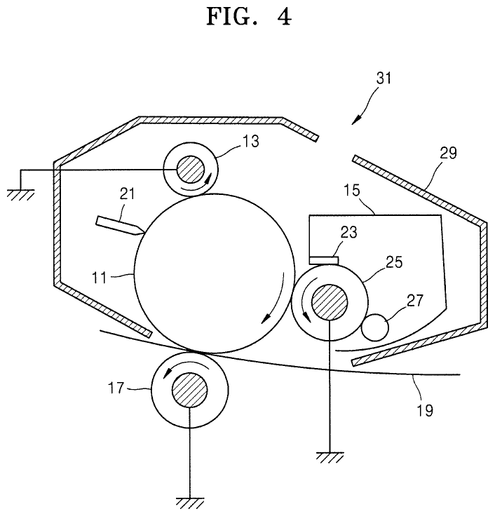

FIG. 4 is a view illustrating an example of an electrophotographic imaging apparatus 31 and an electrophotographic cartridge 29 each including an electrophotographic photoconductor 11 according to an example of the disclosure.

Referring to FIG. 4, the electrophotographic photoconductor 11 has a cylindrical form (i.e., a drum form), and is rotatably driven by a drive member (not shown) at a predetermined circumferential speed in a direction illustrated as the arrow. Around the electrophotographic photoconductor 11, a cleaning device including a charging roller 13, a semiconductor laser (not shown), a developing device 15, a transfer roller 17, and a cleaning blade 21 are provided in this order along the rotational direction of the electrophotographic photoconductor 11. The electrophotographic photoconductor 11 is charged by the charging roller 13, which is a charging member provided in contact or non-contact therewith. Thus, a surface of the electrophotographic photoconductor 11 is uniformly charged to a predetermined positive (+) or negative (−) potential. Subsequently, the surface of the electrophotographic photoconductor 11 is exposed to laser beams (not shown) emitted from the semiconductor laser, thereby forming an electrostatic image on the electrophotographic photoconductor 11. The electrostatic image is developed by the developing device 15 placed downstream side relative to the position of the laser beams (not shown) along the rotational direction of the electrophotographic photoconductor 11, into a visible image, for example, a toner image. Subsequently, the toner image formed on the surface of the electrophotographic photoconductor 11 is transferred to an image-receiving member 19 by using the transfer roller 17 to which a voltage is applied. The image-receiving member 19, such as paper, onto which the toner image has been transferred is transferred to a fuser (not shown) by a transport belt (not shown), and the toner image is fixed onto the image-receiving member 19 by the fuser, thereby forming an image. Toner remaining on the surface of the electrophotographic photoconductor 11 after the transfer of the image is removed by a cleaning device, e.g., a cleaning device including the cleaning blade 21, wherein the cleaning device is installed along with an antistatic lamp (not shown), at a position downstream side of the transfer roller 17 and upstream side of the charging roller 13 along the rotational direction. Subsequently, the above processes are repeated while the electrophotographic photoconductor 11 continues to rotate such that the electrophotographic photoconductor 11 is used again to form an image. The developing device 15 includes a regulating blade 23, a developing roller 25, a supply roller 27, and the like. As such, the image-receiving member 19 on which an image is formed is discharged to the outside of the imaging apparatus.

The electrophotographic photoconductor 11; and, if needed, at least one device selected from the group consisting of the charging roller 13, the developing device 15, and the cleaning device may be integrated as the electrophotographic cartridge 29 that integrally support these. The electrophotographic cartridge 29 may be attachable to or detachable from the electrophotographic imaging apparatus 31.

Hereinafter, the disclosure will be described in further detail with reference to the following examples. However, these examples are provided for illustrative reasons and are not intended to limit the scope of the disclosure.

### Examples 1 to 3 and Comparative Examples 1 to 6: Manufacture of Photoconductor Drums

(1) Preparation of Coating Composition for Undercoat Layer (UCL)

4 kg of zirconium dioxide balls having a mean average diameter of 2 mm were added to a mixed solvent prepared by mixing 320 g of methanol and 80 g of n-propanol, 141 g of titanium dioxide particles (TTO-55N, Ishihara Industrial Manufacturing Co., Ltd., mean primary particle diameter: about 35 nm) were added thereto, and then the resulting dispersion was ball-milled for 16 hours. 400 g of the mixed solvent was further added to the dispersion to disperse the titanium dioxide particles. This is referred to as ‘solution 1’. 90 g of a nylon resin (Toray Industries, Inc., Product name: CM8000) was added to 450 g of methanol and 110 g of n-propanol and dissolved therein. This is referred to as ‘solution 2’. Solutions 1 and 2 were mixed and filtered, and then subjected to ultrasonification, thereby obtaining a coating composition for an undercoat layer.

(2) Preparation of Coating Composition for Charge Generation Layer (CGL)

A mixture of γ-type oxytitanyl phthalocyanine (CGM A) and α-type oxytitanyl phthalocyanine (CGM B) was used as a charge generating material (CGM). The CGM was mixed with polyvinyl butyral (PVB) resin as a binder (Product name: BX-5, manufactured by Sekisui Chemical Co., Ltd.). A mixing weight ratio of CGM A to CGM B to PVB was 40:27:33. 9.7 g of a mixed solvent of methanol and n-propanol (mixing weight ratio=3:1), which is a alcohol-based solvent, was added to 0.3 g of the mixture, and a ball milling process was repeatedly performed thereon to reduce a mean particle diameter of the CGM pigment particles to about 0.3 μm or less, thereby preparing a coating composition for a CGL.

(3) Preparation of Coating Composition for Charge Transport Layer (CTL)

6.27 g of a charge transporting material CTM and 12.73 g of a binder were added to 81 g of a mixed solvent of tetrahydrofuran (THF)/toluene (mixing weight ratio=3:1) and dissolved therein, thereby preparing a composition for a charge transport layer CTL. Compound names of the used CTM were N,N,N,N-tetraphenylbenzidine (Product name: CT-100T, manufactured by IT-Chem) (referred to as ‘CTM-A’), a stilbene-based CTM (Product name: T-405, manufactured by TAKASAGO (referred to as ‘CTM-B’), and a stilbene-based CTM (Product name: HTM-402, manufactured by TAKASAGO) (referred to as ‘CTM-C’). The used binders were polycarbonate Z resin (Product name: TS-2050, manufactured by Teijin Ltd.) (referred to as ‘binder-A’), a silicone-containing bisphenol-type polycarbonate copolymer (Product name: EH503, manufactured by IDEMITSU KOSAN) (referred to as ‘binder-B’), and a bisphenol-type polycarbonate copolymer (Product name: SR600, manufactured by IDEMITSU KOSAN) (referred to as ‘binder-C’). The composition for a CTL included a silicone oil (KF-50, manufactured by SHINETSU KAGAKU Co., Ltd.) and an antioxidant (Irganox 1035, manufactured by BASF) each in an amount of about 2 wt % or less.

At this time, in the case of Comparative Example 1 and Examples 1 to 3, when a coating composition for a CTL was prepared, polytetrafluoroethylene (PTFE) filler particles were further added in amounts of 0.5 wt %, 1.0 wt %, 1.5 wt %, and 2.0 wt %, respectively as shown in Table 1 below, thereby adjusting the hardness of the CTL. For example, in the case of Comparative Example 1, 33 g of a CTM, 67 g of a binder, 0.5 g of PTFE filler particles having a particle diameter of about 200 nm to about 300 nm (Product name: Polyflon PTFE Low Polymer L-2, manufacturer: Dakin Industries), and 0.025 g of a fluorine-based graft polymer GF-400 (Aron GF-400, TOAGOSEI) were added to 400 g of a mixed solvent of THF/toluene (mixing weight ratio=3:1) to prepare a mixed solution having a solid content of 20 wt %, and then the resulting solution was dispersed three times using a wet dispersion device (microfluidizer M-110P) under a condition of a set pressure of 1,500 bar, thereby preparing a CTL solution having a PTFE filler particle content of 0.5 wt % (based on CTM 33 g+binder 67 g=100 g). In the case of Examples 1 to 3, addition amounts of the PTFE filler particles were adjusted to 1.0 wt %, 1.5 wt %, and 2.0 wt %, respectively.

(4) Coating Process

The coating composition for an UCL was applied onto an anodized aluminum pipe having an outer diameter of about 30 mm, a length of about 340 mm, and a thickness of about 0.75 mm by dip coating, and dried in an oven at about 120° C. for about 30 minutes, thereby forming an UCL having a thickness of about 1.2 μm to about 1.3 μm.

Subsequently, the coating composition for a CGL was applied onto the UCL by dip coating and dried in an oven at about 120° C. for about 10 minutes, thereby forming a CGL having a thickness of about 1 μm.

Lastly, the coating composition for a CTL was applied onto the CGL by dip coating, and dried in an oven at about 120° C. for about 1 hour, thereby forming a CTL having a thickness of about 30 μm.

Table 1 below summarizes the compositions of CTLs, which are surface layers of the electrophotographic photoconductor drums manufactured according to Examples 1 to 3 and Comparative Examples 1 to 6, and evaluation results of samples collected from the CTLs.

TABLE 1

| | | CTL composition | | | | | | |
|---|---|---|---|---|---|---|---|---|
| | | | | PTFE | | | Frictional | |
| | Hardness | | | filler | Flip-over of | Tg | force | Torque |
| | (GPa) | CTM | Binder | (wt %) | blade | (° C.) | (gf) | (kgf · cm) |
| Comparative | 0.203 | CTM-C | Binder-C | 0.5 | NG | 98 | — | — |
| Example 1 | | | | | | | | |
| Example 1 | 0.227 | CTM-C | Binder-C | 1.0 | OK | 103 | — | — |
| Example 2 | 0.247 | CTM-C | Binder-C | 1.5 | OK | 107 | 0.66 | 2.13 |
| Example 3 | 0.283 | CTM-C | Binder-C | 2.0 | OK | 113 | — | — |
| Comparative | 0.138 | CTM-C | Binder-C | — | NG | 89 | 0.59 | 2.36 |
| Example 2 | | | | | | | | |
| Comparative | 0.078 | CTM-A | Binder-A | — | NG | 71 | 0.59 | — |
| Example 3 | | | | | | | | |
| Comparative | 0.082 | CTM-B | Binder-A | — | NG | 86 | 0.50 | — |
| Example 4 | | | | | | | | |
| Comparative | 0.057 | CTM-A | Binder-A | — | NG | 63 | — | — |
| Example 5 | | | | | | | | |
| Comparative | 0.085 | CTM-B | Binder-B | — | NG | 88 | 0.32 | — |
| Example 6 | | | | | | | | |

The characteristics of the sample collected from a surface of each of the photoconductor drums of Examples 1 to 3 and Comparative Examples 1 to 6, which are summarized in Table 1, were evaluated according to the following procedures.

[Measurement of Glass Transition Temperature Tg]

The glass transition of a sample is detected as a baseline shift on a differential scanning calorimetry (DSC) curve in a stepwise manner. The glass transition changes in accordance with the thermal history of the sample and measurement speed. In the disclosure, values used were measured while about 10 mg of each of the samples collected from the surfaces of the photoconductors was maintained in a nitrogen atmosphere and at 40° C. for about 10 minutes, and then heated once at a temperature ranging from 40° C. to 140° C. at a heating rate of 10° C./min. In the disclosure, an instrument used for Tg measurement was a Q2000 Differential Scanning calorimeter manufactured by TA Instruments.

In the disclosure, a temperature at the midpoint of the stepped or sloping DSC curve region where baseline shift occurs was not read as Tg, but a temperature at the point where the baseline shift begins was read as Tg. This is because it is believed that a temperature at the first inflection point at which such transition begins has a greater effect on the characteristics of friction with the cleaning blade.

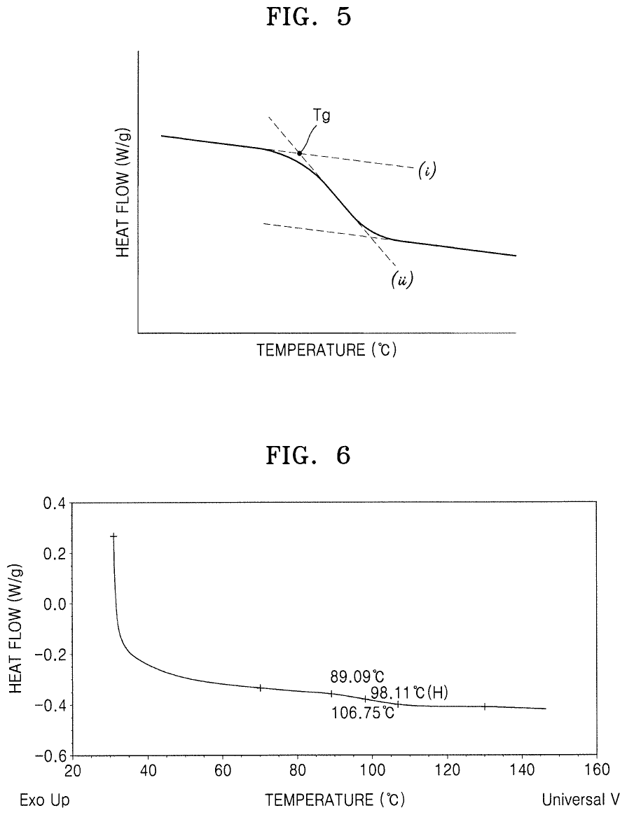

FIG. 5 is a graph for explaining the concept of reading a DSC curve of a glass transition temperature Tg used in the disclosure. Referring to FIG. 5, the glass transition temperature Tg on the DSC curve obtained under the above-described conditions and using the above-described method is defined as a temperature at a point at which a dotted straight line (i) plotted on the DSC curve at a low-temperature region intersects with a dotted straight line (ii) plotted at a middle-temperature region representing baseline shift of the DSC curve as the temperature increases. In other words, if there are sloping baselines before and after the glass transition, the baseline before the transition is extrapolated forwards and the baseline after the transition is extrapolated backwards (as shown by dotted straight lines (i) and (ii)). Here, the dotted straight line (i) is a straight line plotted such that the length at which this straight line is in contact with the DSC curve is the longest at the low-temperature region having a plateau shape. The dotted straight line (ii) is a straight line plotted such that the length at which this straight line is in contact with the DSC curve is the longest at the middle-temperature region representing a baseline shift. In practice, this value is automatically calculated and displayed on the DSC curve produced by a Q2000 Differential Scanning calorimeter manufactured by TA Instruments through software processing provided by this instrument. For example, a glass transition temperature on the DSC curve of FIG. 6 for the sample of Comparative Example 2 is defined as 89.09° C., which is a temperature at the first inflection point, and 98.11° C. at the midpoint of the stepped or sloping DSC curve region is not regarded as the glass transition temperature in the disclosure.

Referring to Table 1, it can be confirmed that the Tg of the samples collected from the surfaces of the electrophotographic photoconductor drums of Examples 1 to 3 and Comparative Examples 1 to 6 varied from 63° C. to 113° C. Analysis indicates that this depends on the properties of components constituting the CTL. In addition, referring to Comparative Example 1 and Examples 1 to 3, from which an effect of the PTFE filler particles according to an amount can be confirmed, it can be confirmed that the Tg of the sample also increases in accordance with an increase in the amount of the PTFE filler particles. Referring to the DSC results of Comparative Example 1 and Examples 1 to 3, it can be confirmed that these also exhibit a single-phase thermal behavior. Analysis indicates that this is a thermal change of the matrix-phase. Considering the occurrence of a phenomenon in which binder resin chains bind to outer surfaces of the filler particles, analysis indicates that the filler particles restrict the movement of the binder resin chains. It may be understood that this does not form a dense three-dimensional network structure due to chemical bonding, but forms a three-dimensional structure due to non-dense physical bonding such that the binder resin chains are physically bound around the filler particles.

Referring to Table 1, it can be confirmed that the filler particles restrict the molecular motion of the binder resin chains, which is predicted to be occur around Tg, thereby increasing the Tg values of the samples collected from the surfaces of the photoconductors. Due to the same reason, as described below in detail, it can be confirmed that the presence of the filler particles also increases the hardness of each sample.

[Hardness Measurement]

Hardness was measured using an indentation test in which a diamond indenter was pressed towards each sample under conditions of a maximum indentation limit of about 3,000 nm and a strain rate of about 0.05/s using a Nanoindenter XP instrument manufactured by MTS Systems Corporation. At this time, a Berkovitch tip having a three-sided diamond pyramid shape was used as the diamond indenter for hardness measurement, and the thickness of each sample collected from the surface of the photoconductor was maintained at about 30 μm. Hardness is measured using an Oliver-Pharr method, and is actually calculated automatically by software provided by an Nanoindenter XP instrument available from MTS Systems Corporation.

Referring to Table 1, it can be confirmed that a difference in hardness between the samples is significant. For example, referring to the samples including the PTFE filler particles (Comparative Example 1 and Examples 1 to 3), it can be seen that hardness increases as the amount of the filler particles increases. Although the increase in hardness in accordance with the increase in the amount of the filler particles is a natural result in a sense, as described above, it is analyzed that this is also affected by the fact that the molecular motion of the binder resin chains is restricted by the presence of the filler particles.

[Torque Measurement]

A torque applied to each photoconductor drum was measured using a BTG torque gauge (Model name: 9BTG) available from TOHNICHI in a state in which a cleaning blade is in contact with each photoconductor drum. That is, the torque applied to each photoconductor drum was measured in a state in which the cleaning blade acted as a factor for generating a main torque to each photoconductor drum. For measurement accuracy, a new cleaning blade was always used in measurement. The measurement was performed at room temperature, and a total of ten measurements was made to compare average values. Torque was measured in HH, LL or NN conditions to check whether there was any difference by environment. HH condition denotes temperature of 32° C./relative humidity of 80%, NN condition denotes 23° C./50%, and LL condition denotes 10° C./20%.

As the measured torque value is smaller, the flip-over of a cleaning blade may be prevented more effectively, and thus the cleaning characteristics of the cleaning blade may remain good.

Table 2 below summarizes torque values of the photoconductor drums of Example 2 and Comparative Example 2, which were measured a total of ten times under respective environmental conditions.

TABLE 2

| | Torque measurement value (kgf · cm) | | | | | | | | | | |
|---|---|---|---|---|---|---|---|---|---|---|---|
| | 1^{st} | 2^{nd} | 3^{rd} | 4^{th} | 5^{th} | 6^{th} | 7^{th} | 8^{th} | 9^{th} | 10^{th} | |
| | time | time | time | time | time | time | time | time | time | time | Average |
| Example 2 (NN) | 1.8 | 2.04 | 2.15 | 2.1 | 2.06 | 2.25 | 2.16 | 2.25 | 2.25 | 2.24 | 2.13 |
| Example 2 (HH) | 2.25 | 2.3 | 2.35 | 2.36 | 2.38 | 2.35 | 2.39 | 2.35 | 2.35 | 2.35 | 2.34 |
| Example 2 (LL) | 2.05 | 2.15 | 2.04 | 2.1 | 2.1 | 2.25 | 2.1 | 2.19 | 2.17 | 2.19 | 2.13 |
| Comparative | 2.38 | 2.33 | 2.4 | 2.4 | 2.43 | 2.3 | 2.36 | 2.25 | 2.35 | 2.4 | 2.36 |
| Example 2 (NN) | | | | | | | | | | | |
| Comparative | 2.14 | 2.2 | 2.1 | 2.17 | 2.2 | 2.17 | 2.17 | 2.17 | 2.2 | 2.14 | 2.17 |
| Example 2 (HH) | | | | | | | | | | | |
| Comparative | 2.58 | 2.65 | 2.54 | 2.6 | 2.6 | 2.59 | 2.65 | 2.55 | 2.55 | 2.5 | 2.58 |
| Example 2 (LL) | | | | | | | | | | | |

Referring to Table 2, it can be seen that changes in a torque value according to changes in temperature and humidity are not large, and a difference between Example 2 and Comparative Example 2 is not significant. From these results, it can be confirmed that the torque value does not have a large influence on the flip-over of the cleaning blade, and is not a valid parameter for controlling the flip-over of the cleaning blade.

[Frictional Force Measurement]

A frictional force applied to each photoconductor drum was measured using a push-pull gauge (Model name: DS2-5N) available from IMADA in a state in which the cleaning blade is in contact with each photoconductor drum. That is, in a state in which the cleaning blade was brought into contact with each photoconductor drum so as to have a constant nip pressure and angle, the push-pull gauge was connected to the surface of each photoconductor drum through a frame holding the cleaning blade, and frictional force values were measured. For each sample, the maximum frictional force value was measured three times at three different positions, and an average value was obtained therefrom, and results thereof are shown in Table 3 below.

TABLE 3

| | Measurement | Measurement value | | | | Friction force |
|---|---|---|---|---|---|---|
| | position | (Maximum value) (gf) | | | Average | value (gf) |
| Example 2 | #1 | 0.70 | 0.90 | 0.80 | 0.80 | 0.66 |
| | #2 | 0.80 | 0.70 | 0.50 | 0.67 | |
| | #3 | 0.55 | 0.55 | 0.40 | 0.50 | |
| Comparative | #1 | 0.50 | 0.50 | 0.55 | 0.52 | 0.59 |
| Example 2 | #2 | 0.70 | 0.60 | 0.70 | 0.67 | |
| | #3 | 0.70 | 0.60 | 0.50 | 0.60 | |
| Comparative | #1 | 0.70 | 0.60 | 0.70 | 0.67 | 0.59 |
| Example 3 | #2 | 0.60 | 0.70 | 0.60 | 0.63 | |
| | #3 | 0.40 | 0.55 | 0.50 | 0.48 | |
| Comparative | #1 | 0.65 | 0.40 | 0.50 | 0.52 | 0.50 |
| Example 4 | #2 | 0.50 | 0.55 | 0.50 | 0.52 | |
| | #3 | 0.45 | 0.45 | 0.50 | 0.47 | |
| Comparative | #1 | 0.35 | 0.25 | 0.35 | 0.32 | 0.32 |
| Example 6 | #2 | 0.30 | 0.25 | 0.30 | 0.28 | |
| | #3 | 0.35 | 0.30 | 0.40 | 0.35 | |

Referring to Table 3, Comparative Example 6 exhibits the lowest frictional force value. It is thought that this is because the binder-B includes a silicone component and thus has a low surface energy. The effect of the PTFE filler particles was confirmed from comparison between Example 2 and Comparative Example 2, but results thereof were contrary to the torque measurement results. This is surely due to a difference between the frictional force measurement method and the torque measurement method, although more analysis is needed. However, as seen from the results of comparative examples, it has not been found that a case of low friction has a positive effect on cleaning blade flip-over. Thus, it can be seen that the frictional force value does not have a great effect on the flip-over of a cleaning blade and is not a valid parameter for controlling the flip-over of a cleaning blade.

[Evaluation of Flip-Over of Cleaning Blade]

A difference between the photoconductor drums was determined by relatively evaluating a degree to which each photoconductor drum caused the flip-over of each cleaning blade under the same given conditions. While each photoconductor drum was rotated (at a speed of about 100 rpm) for a maximum of 10 minutes, it was examined whether the cleaning blade coming into contact therewith was flipped over. The surface temperature of each photoconductor drum was raised to a maximum of 55° C. so as to become close to an environment when an imaging apparatus was actually operated. The temperature raising process is as follows: first, the test started at room temperature and the surface temperature of each photoconductor drum reached 55° C. after 5 minutes. Subsequently, the surface temperature of the photoconductor drum was maintained at 55° C. for 5 minutes. A case in which evaluation for a total of 10 minutes passed without any issue was evaluated as ‘OK,’ whereas a case in which the flip-over of the blade occurred was evaluated as NG (i.e., FLIP occurrence). Test results are shown in Table 4 below. The thickness of each cleaning blade was about 2 mm, and each cleaning blade had a free length of about 8 mm. The free length of the cleaning blade denotes a portion of the cleaning blade which is not attached to a support member. The nip pressure applied to the blade was about 30 gf, a constant pressure method was employed, and a cleaning angle defined as an angle between the surface of the photoconductor and the cleaning blade, i.e., a working angle was fixed at about 15°.

Noise levels were also evaluated along with the flip-over evaluation. Relative evaluation was performed using a scale of noise levels 1 to 5. Noise level 1 is a good state with low noise level, and noise level 5 is the worst state with high noise level.

Noise level 1: very low noise level at which those who are sensitive to noise complain about the noise

Noise level 2: acceptable low noise level for most people

Noise level 3: somewhat high noise level acceptable to some people

Noise level 4: high noise level unbearable for most people

Noise level 5: very high noise level unbearable for all people

TABLE 4

| | | | | Surface | | |
|---|---|---|---|---|---|---|
| | Working | | Whether | temperature of | Elapsed | |
| | angle | Nip | flipped | photoconduct or | time | Noise |
| | (°) | pressure | over | drum (° C.) | (min) | level |
| Comparative | 15 | Constant | FLIP | 42 | 2:49 | 5 |
| Example 1 | | pressure | | | | |
| | | (30 gf) | | | | |
| Example 1 | 15 | Constant | OK | 55 | 10:00 | 1 |
| | | pressure | | | | |
| | | (30 gf) | | | | |
| Example 2 | 15 | Constant | OK | 55 | 10:00 | 1 |
| | | pressure | | | | |
| | | (30 gf) | | | | |
| Example 3 | 15 | Constant | OK | 55 | 10:00 | 1 |
| | | pressure | | | | |
| | | (30 gf) | | | | |
| Comparative | 15 | Constant | FLIP | 55 | 4:20 | 1 |
| Example 2 | | pressure | | | | |
| | | (30 gf) | | | | |
| Comparative | 15 | Constant | FLIP | 48 | 3:48 | 1 |
| Example 3 | | pressure | | | | |
| | | (30 gf) | | | | |
| Comparative | 15 | Constant | FLIP | 50 | 4:17 | 1 |
| Example 4 | | pressure | | | | |
| | | (30 gf) | | | | |
| Comparative | 15 | Constant | FLIP | 41 | 2:00 | 1 |
| Example 5 | | pressure | | | | |
| | | (30 gf) | | | | |
| Comparative | 15 | Constant | FLIP | 55 | 6:30 | 1 |
| Example 6 | | pressure | | | | |
| | | (30 gf) | | | | |

Referring to Table 4, it can be confirmed that the photoconductor drums of Examples 1 to 3 do not cause the cleaning blades to be flipped over and also have low noise levels.

From the above results, it can be seen that hardness and Tg of the surface of the photoconductor may be selected as factors that affect the flip-over of the blade, and for example, the surface properties of the photoconductor at a high temperature affect the flip-over of the blade. That is, as the surface properties of the photoconductor at a low temperature were maintained at a high temperature, there may be more stability against the flip-over of the blade. A high Tg and a high hardness of the surface of the photoconductor may be regarded as representative properties thereof.

From the above-described characteristic evaluation results, it was confirmed that there was a difference between a frictional force and a torque, which are main properties for the flip-over of the cleaning blade, but these were not direct causes of the flip-over of the blade at a high temperature.

Referring to Table 1 that summarizes the above results again, it can be confirmed that the Tg value and hardness value of the surface of the photoconductor are valid parameters capable of controlling the flip-over of the cleaning blade. Although a direct relationship between the Tg value and the hardness value has not been found, a sample having a higher Tg value exhibited a higher hardness value. Here, Tg denotes a value corresponding to the first inflection point of a sample as described above. When the flip-over results of the blade were compared with the hardness value, it was confirmed that good results without the flip-over of the blade could be obtained when the hardness value exceeded 0.22 GPa and the Tg value exceeded 100° C. To secure these hardness values, it was confirmed that a binder resin and a CTM, which are major components of a CTL, acted as main factors. These may act as effective factors in photoconductor material selection.

What is claimed is:

1. An electrophotographic photoconductor, comprising:
an electroconductive support; and
a photosensitive layer on the electroconductive support comprising one or more layers, a top layer of the photosensitive layer among the one or more layers of the photosensitive layer having properties that satisfy conditions (1) and (2) below:
Tg>100° C. (1), and
hardness>0.22 GPa (2),
wherein Tg denotes a glass transition temperature of the photosensitive layer.

2. The electrophotographic photoconductor of claim 1, wherein
the photosensitive layer is a laminated-type photosensitive layer or a monolayer-type photosensitive layer,
the laminated-type photosensitive layer comprises a charge generation layer and a charge transport layer that are sequentially stacked, the charge generation layer comprising a charge generating material and the charge transport layer comprising a charge transporting material, and
the monolayer-type photosensitive layer comprises a charge generating material and a charge transporting material.

3. The electrophotographic photoconductor of claim 3, wherein
the charge transport layer or the monolayer-type photosensitive layer further comprises a binder resin,
a mass ratio (A/B) of the charge transporting material (A) of the charge transport layer to the binder resin (B) of the charge transport layer is in a range of about 10/10 to about 10/30, and
a mass ratio (A/B) of the charge transporting material (A) of the monolayer-type photosensitive layer to the binder resin (B) of the monolayer-type photosensitive layer is in a range of about 10/10 to about 10/30.

4. The electrophotographic photoconductor of claim 1, wherein an overcoat layer is the top layer of the photosensitive layer.

5. The electrophotographic photoconductor of claim 4, wherein the overcoat layer comprises a binder resin and an electroconductive material.

6. The electrophotographic photoconductor of claim 5, wherein the binder resin is a photocured product of at least one photocurable compound selected from the group consisting of a monofunctional (meth)acrylic acid ester, a bifunctional (meth)acrylic acid ester, or a trifunctional or greater (meth)acrylic acid ester.

7. The electrophotographic photoconductor of claim 5, wherein the electroconductive material comprises at least one selected from the group consisting of copper, tin, aluminum, indium, silica, tin oxide, zinc oxide, titanium dioxide, aluminum oxide (Al₂O₃), zirconium oxide, indium oxide, antimony oxide, bismuth oxide, calcium oxide, antimony-doped tin oxide (ATO), or carbon nanotubes.

8. An electrophotographic cartridge for an electrophotographic imaging apparatus, comprising:
an electrophotographic photoconductor; and
at least one device selected from the group consisting of a charging device to charge the electrophotographic photoconductor, a developing device to form a visible image by developing the electrostatic image formed on the electrophotographic photoconductor, or a cleaning device to clean a surface of the electrophotographic photoconductor,
wherein
the electrophotographic photoconductor comprises:
an electroconductive support, and
a photosensitive layer on the electroconductive support comprising one or more layers, a top layer of the photosensitive layer among the one or more layers of the photosensitive layer having properties that satisfy conditions (1) and (2) below:
Tg>100° C. (1), and
hardness>0.22 GPa (2),
wherein Tg denotes a glass transition temperature of the photosensitive layer,
or
the electrophotographic photoconductor comprises:
an electroconductive support,
a photosensitive layer on the electroconductive support comprising one or more layers, and
an overcoat layer is a top layer of the photosensitive layer among the one or more layers of the photosensitive layer, the overcoat layer having properties that satisfy conditions (1) and (2).

9. The electrophotographic cartridge of claim 8, wherein
the cleaning device comprises a cleaning blade to remove a residue on the surface of the electrophotographic photoconductor while in contact with the surface, and
a storage modulus G′ in units of MPa, G′(MPa), of the cleaning blade satisfies the following conditions:
27<G′(MPa)@−5° C.<32,
10<G′(MPa)@23° C.<16, and
12<ΔG′(MPa),−5° C.˜23° C.)<21,
wherein the storage modulus values for each of the above conditions are obtainable by a dynamic viscoelastic measurement conducted as a function of temperature at a temperature ranging from about −80° C. to about 50° C. in a nitrogen atmosphere and at a measurement frequency of about 10 Hz, a heating rate of about 2.0° C./min, and an initial strain of about 0.03%.

10. The electrophotographic cartridge of claim 8, wherein
the photosensitive layer is a laminated-type photosensitive layer or a monolayer-type photosensitive layer,
the laminated-type photosensitive layer comprises a charge generation layer and a charge transport layer that are sequentially stacked, the charge generation layer comprising a charge generating material and the charge transport layer comprising a charge transporting material, and
the monolayer-type photosensitive layer comprises a charge generating material and a charge transporting material.

11. The electrophotographic cartridge of claim 10, wherein
the charge transport layer or the monolayer-type photosensitive layer further comprises a binder resin,
a mass ratio (A/B) of the charge transporting material (A) of the charge transport layer to the binder resin (B) of the charge transport layer is in a range of about 10/10 to about 10/30, and
a mass ratio (A/B) of the charge transporting material (A) of the monolayer-type photosensitive layer to the binder resin (B) of the monolayer-type photosensitive layer is in a range of about 10/10 to about 10/30.

12. The electrophotographic cartridge of claim 8, wherein the overcoat layer comprises a binder resin and an electroconductive material.

13. The electrophotographic cartridge of claim 12, wherein the binder resin is a photocured product of at least one photocurable compound selected from the group consisting of a monofunctional (meth)acrylic acid ester, a bifunctional (meth)acrylic acid ester, or a trifunctional or greater (meth)acrylic acid ester.

14. An electrophotographic imaging apparatus, comprising:
an electrophotographic photoconductor;
a charging device to charge the electrophotographic photoconductor;
an exposure device to form an electrostatic image on a surface of the electrophotographic photoconductor;
a developing device to form a visible image by developing the electrostatic image;
a transfer device to transfer the visible image onto an image-receiving member; and
a cleaning device to clean the surface of the electrophotographic photoconductor after the transfer of the visible image,
wherein
the electrophotographic photoconductor comprises:
an electroconductive support, and
a photosensitive layer on the electroconductive support comprising one or more layers, a top layer of the photosensitive layer among the one or more layers of the photosensitive layer having properties that satisfy conditions (1) and (2) below:
Tg>100° C. (1), and
hardness>0.22 GPa (2),
wherein Tg denotes a glass transition temperature of the photosensitive layer,
or
the electrophotographic photoconductor comprises:
an electroconductive support,
a photosensitive layer on the electroconductive support comprising one or more layers, and
an overcoat layer is a top layer of the photosensitive layer among the one or more layers of the photosensitive layer, the overcoat layer having properties that satisfy conditions (1) and (2).

15. The electrophotographic imaging apparatus of claim 14, wherein
the cleaning device comprises a cleaning blade to remove a residue on the surface of the electrophotographic photoconductor while in contact with the surface, and
a storage modulus G′ in units of MPa, G′(MPa), of the cleaning blade satisfies the following conditions:
27<G′(MPa)@−5° C.<32,
10<G′(MPa)@23° C.<16, and
12<ΔG′(MPa),−5° C.˜23° C.)<21,
wherein the storage modulus values for each of the above conditions are obtainable by a dynamic viscoelastic measurement conducted as a function of temperature at a temperature ranging from about −80° C. to about 50° C. in a nitrogen atmosphere and at a measurement frequency of about 10 Hz, a heating rate of about 2.0° C./min, and an initial strain of about 0.03%.
